(19) United States
(12) Patent Application Publication
(10) Pub. No.: US 2018/0065882 A1
(43) Pub. Date: Mar. 8, 2018

(54) METHOD OF MAKING POROUS MONO CORDIERTIE GLASS CERAMIC MATERIAL AND ITS USE

(71) Applicant: King Abdulaziz City for Science and Technology (KACST), Riyadh (SA)

(72) Inventors: Omar Assaf Al-Harbi, RIYADH (SA); Esmat Mahmoud Hamzawy, Cairo (EG)

(73) Assignee: King Abdulaziz City for Science and Technology (KACST), RIYADH (SA)

(21) Appl. No.: 15/258,021

(22) Filed: Sep. 7, 2016

(51) Int. Cl. C03C 11/00; C03C 10/00; C03C 8/02; C03B 19/06

(52) U.S. Cl. CPC C03C 11/00; C03C 10/0045; C03C 2204/00; C03C 8/02; C03B 19/06; C03C 10/0054

(57) ABSTRACT

A sintered porous cordierite-based glass-ceramic material is made using mainly three natural starting materials which are silica′ sand, kaolin clay and magnesite in addition to little boric acid is described. Upon melting at 1400-1450° C., this combination of raw materials and boric acid forms transparent brown glass which after solidification by quenching is then crushed and reduced to powder having a median particle size diameter less than 65 microns. This brown glass powder is consolidated, for example by compaction, to form a green body for sintering. Sintering of the green body at temperatures between about 1000° C. and 1300° C. in the period from 1 min to 60 min to produce porous cordierite glass-ceramic material containing a 56% porosity. The said material have density, microhardness and CTE suitable for use in various technical fields such as light insulation refractor material and in filter for vehicle exhaust.

### FIELD OF INVENTION

The present invention relates to the method of making a porous mono-cordierite glass-ceramic material prepared mainly using kaolin, magnesite and silica′ sand and commercial boric acid.

### BACKGROUND

Micro- and Macro-porous materials are used in various forms and compositions in everyday life, including for instance polymeric foams for packaging, aluminum light-weight structures in buildings and airplanes, as well as porous ceramics for water purification. Number of applications that require porous ceramics have appeared in the last decades, especially in environments where high temperature resistance, high-temperature thermal insulation, filtration of particulates from diesel engine, filtration of hot corrosive gases in various industrial process exhaust gases extensive wear and corrosive media are involved. The most popular industrial processes in the manufacture of porous ceramics with controlled pore volume and pore size are the replica polymer sponge and indirect or direct foaming (Studart et al, 2006).

Cordierite (2MgO-2Al₂O₃-5SiO₂) enjoys low thermal expansion coefficient and high resistance to thermal shock, therefore it has been one of the most potential ceramics due to many industrial applications, such as catalysts, microelectronics, refractory products, integrated circuit boards, heat exchange for gas turbines, membranes, thermal shock-resistance table ware and porous ceramics (Höland, G. H. Beall, 2002).

Through ceramic route, many works were worked on the porous cordiertite ceramic. A porous cordierite was synthesized at 1350° C. using rice husk as the silica source and pore forming agent, and La₂O₃ as fluxing (Guo et al 2010). Porous cordierite ceramics were produced, at 1300° C. for 2 h, from stevensite-rich clay and alusite mixture using oil shale (OS) as a natural pore-forming agent. (Benhammou et al. 2014). Cordierite-mullite bonded porous SiC ceramics were prepared, within 1300-1450° C. temperatures, by an in situ reaction bonding technique using a silicon carbide, aluminum hydroxide, magnesium oxide and graphite as starting material (Cheng-Ying Bai et al 2014). The association of foaming and gel-casting of ceramic slurry was successfully applied to the fabrication of porous cordierite to have 75˜83% porosity (Izuhara, K. Kawasumi et al 2000). Porous ceramic cordierite was prepared from the designed raw materials (fume silica, talc and bauxite). The later raw materials were dispersed in solution (pH8) with the addition of sodium silicate for dispersion and aluminum mono-phosphate as a binder. Also, polyurethane was added as foaming agent then samples sintered similar to untreated condensed cordierite ceramic. This method gives ˜46% porosity in cordierite (Ewais et al 2009). Open cell cordierite foams were prepared by a direct foaming two-component polyurethane (PUR)/ceramic system (Silva, et al, 2007).

In the glass-ceramic method, rare or little work was done on porous cordierite glass-ceramic product. Ni-containing cordierite glass-ceramics are candidate materials for development of nano-porous, of non-stoichiometric spinel NixMg1-xAl2O4, for gas separation membranes (Miller, 2008). However, a highly porous glass-ceramic molded parts produced by the process which have carbon atoms attached to the silicon atoms, have a density of from 0.7 to 0.8 g/cm3 at a porosity of from 60 to 70 percent. They are electrically non-conductive and have good resistance to temperature changes up to 1000° C. They are thermally resistant up to a temperature of 1300° C. (Volker Frey et al 1993). Using an aqueous solution, organic solvent solution, or molten salt, as porous glass matrix, nano-crystalline porous spinel glass-ceramic was obtained, which enjoy magnetism, low Fe2+ concentrations, optical transparency in the near-infrared spectrum, and low scattering losses (Matthew J Dejneka, Christy L Powell, 2007). However, the present authors prepared cordierite glass-ceramic bodies completely from raw materials. Also, one of both authors had been prepared cordierite through solgel and ceramic routs (Hamzawy et al 2005, Hamzawy and Ashraf 2006).

The aforementioned literature clear that porous cordierite ceramic was prepared widely using a polymer or natural hydrocarbon containing materials as oil shale, also the same materials may be used in preparation of porous cordierite glass-ceramic. There is a need for purer self porous material without any additives and that cost less to make.

### SUMMARY

The present invention is directed to a method for making a porous mono-cordierite glass-ceramic material starting from natural raw materials and commercial boric acid. In one embodiment, porous mono-cordierite glass-ceramic material possesses specific range of density, microhardness and coefficient of thermal expansion (CTE) that makes it suitable of a variety uses including filtration equipment and as light refractoriness insulation panels.

In one embodiment, the natural raw materials such as silica sand, kaolin, magnesite and commercial boric acid are combined. In another embodiment, raw materials are combined in relative amounts suitable to provide the correct density, microhardness and CTE, upon the subsequent homogenization and sintering method. In another embodiment, a mixture of oxides comprising ranging from 50 wt % to 60 wt % of SiO₂; 10 wt % to 25 wt % of Al₂O₃, 5 wt % to 20 wt % B₂O₃, 10 wt % to 15 wt % of MgO, 0.5 wt % to 2.50 wt % of TiO₂ and 0.5 to 1.50 wt % of Fe₂O₃ for the composition and method of making the porous mono-cordierite glass-ceramic material.

In another embodiment, in the second step of the method herein, the combination of the natural raw materials with the commercial boric acid are melted at a temperature between 1400° C. to 1450° C. to form glass material. This molten glass material is then quenched to solid form as glass frits.

In a third step of the process, the quenched glass frits are crushed into powder having a median particle size diameter of no greater than 65 microns. And in a fourth process step, the powder material so formed is consolidated into a body or structure. In a fifth process step, the body of material formed from the powder is sintered at a temperature of from about 1000° C. up to 1300° C.

Variation of porosity takes place from >1200 to 1300° C. The prepared glass-ceramic enjoy low thermal expansion, low density and good hardness. The present porous glass-ceramic can use in light insulation panels even 1000° C. and may be as gas filters. However, the local raw materials from Saudi Arabia were used as starting materials in the present work. The using of the local raw materials in about >85% will reduce the cost of the product.

In a final process step, the sintered material from the fifth process step is cooled to provide a porous glass-ceramic material have a crystalline material from cordierite. This porous cordierite-based glass ceramic material will preferably have a density ranging from about 1.70 to 2.04 g/cc, Porosity % from 8.99 to 56.42%. It also enjoys a microhardness value ranging from about 560 to 660 kg/mm2 and coefficient of thermal expansion (CTE) which ranges from about 32.63 to −14.44×10-7° C.-1 in the temperature range of from room temperature to 300 and 500° C.

Additional features and advantages are realized through the techniques of the present invention. These embodiments and aspects of the invention are described in detail herein and are considered a part of the claimed invention. For a better understanding of the invention with advantages and features, refer to the description and to the drawings.

### BRIEF DESCRIPTION THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a flow chart showing the several steps of the glass-ceramic preparation process herein.

FIGS. 2A and 2B shows differential thermal analysis of the glass sample in bulk and powder state.

FIGS. 3 and 4 show morphology of the sintered sample at 1300° C.

FIG. 5 and FIG. 6 shows x-ray diffraction patterns of the sintered glass samples sintered at 1100, 1150, 1200 and 1250° C. FIG. 6 shows the x ray patterns of the sample sintered 1300° C.

FIGS. 7A, 7B, 7C, 7D, and 7E shows several SEM micrographs of the glass-ceramic samples sintered at 1100, 1150, 1200, 1250 and 1300° C. at X 150.

FIGS. 8A, 8B, 8C, 8D and 8E shows several SEM micrographs of the glass-ceramic samples sintered at 1100, 1150, 1200, 1250 and 1300° C. at X 1500.

FIG. 9A shows the median pore diameter (volume) and 9B the median pore diameter (area).

FIG. 10 shows the EDX microanalysis of the glass-ceramic samples.

### DETAILED DESCRIPTION

In this invention the preparation of cordierite-containing glass-ceramic material at low temperature took place. The starting materials are natural materials in addition to little commercial boric acid as the source for B₂O₃.

For the preparation of the glass ceramic bodies in the present work, three natural raw materials are used. These raw materials include silica sand, kaolin clay and the magnesite. These three raw material types are combined with the boric acid in chosen amounts which are calculated to provide upon subsequent good homogenization mixing.

The mixture of batch after combining and homogenizing and three essential raw materials with commercial boric acid must comprise from about 50 wt % to 60 wt % of SiO₂ (silicon dioxide), from about 10 wt % to 25 wt % of Al₂O₃ (alumina); from about 10 wt % to 15 wt % of MgO (magnesia or magnesium oxide); from about 5.0 to 20.0 of B₂O₃ (boron oxide); from about 0.5 wt % to 2.5 wt % of TiO₂ (titanium dioxide) and from about 0.5 wt % to 1.5 wt % of Fe₂O₃ (ferric oxide or iron III oxide). Also the mixture of oxides provided by combining the three essential raw materials with little oxides comprise from 0.50 to 1.50 wt % of CaO; from 0.01 to 0.20 wt % of Na₂O and from 0.01 to 0.20 wt % K₂O.

The used natural raw materials are available geographically in Saudi Arabian Silica′ sand is used as the main source of SiO₂ in the batch mixture of oxides which are formed from the combination of raw materials. Kaolin clay is the principal source of Al₂O₃ to be found in the batch mixture of oxides described above. Kaolin clay also supplies SiO₂ to the oxide mixture as well as little amounts of TiO₂, Fe₂O₃, Na₂O, K₂O and CaO. Magnesite is the main source of MgO and may also contain small amounts CaO, Al₂O₃ as well as very small amounts of K₂O, Fe₂O₃, Na₂O, and TiO₂.

The three essential raw materials with the commercial boric acid are preferably mixed in any conventional tool to get homogenous mixture. That is done by using crushing, grinding and/or milling to provide the desired substantially uniform particle blend. The mixture of batch is melted at a temperature of from about 1400° C. to 1450° C. to form amorphous glass material. Melting takes place in sintered alumina crucible in a globular furnace. To ensure homogenization 3 to 4 times swirling take place during the melting process.

The resulting amorphous glass melt is solidified by discharging the melt into normal water. The result after the water quenching is a transparent brown glass. The brown glass material can be converted to powder size particles using ball mill. The desired grain size of glass powder was <0.065 mm. For consolidation into a body, the glass powder material was combined with a binder (7% PVA). Such consolidation was carried out in a suitable round mold using uniaxial pressing (˜20 KN).

The consolidated material from the glass powder is sintered in order to devitrify at least a portion of the glass into a crystalline material. Sintering of the body is carried out at a temperature of from about 1000° C. to 1300° C. for a period of time from about 0 to 60 minutes. However drying of the consolidated disc for evaporation of organic binder took about 1 h before the sintering process.

In the ending, the sintered body is cooled to provide a porous glass-ceramic material comprising a mono-crystalline cordierite. This mono-crystalline material will comprise about 70 to 80 wt % of the glass-ceramic body. Generally the glass batch of the glass-ceramic material is containing 80 to 90% raw materials and about 10 to 20% commercial chemicals (B₂O₃). The sintered glass-ceramic have yellowish creamy colour.

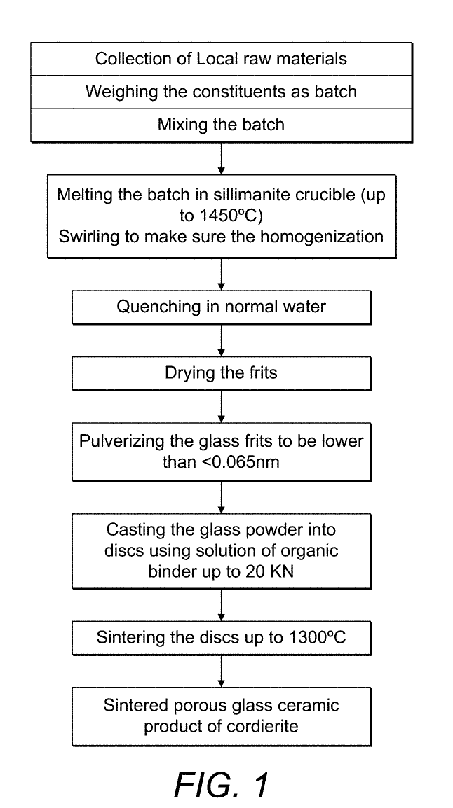

The procedure for preparing the porous cordierite-based glass-ceramic bodies are further illustrated by FIG. 1. The flow chart in FIG. 1 showing the steps of the glass ceramic synthesis procedure starting with the formation of the mixture of the three types of raw materials with the commercial boric acid and ending with the porous cordierite glass-ceramic body.

The porous cordierite glass-ceramic bodies prepared as described herein (from natural raw materials, from Saudi Arabia, with commercial boric acid) have low density, good microhardness values, low coefficient of thermal expansion, high resistance to heat and deformation and high resistance to thermal shocks. These properties make such porous glass-ceramic bodies herein especially useful as light insulation panel, gas filtration and as refractoriness in safe up to 1000° C.

The density of the sintered glass-ceramic samples prepared as described herein can range from about 1.9880 to 1.1278 g/ml for bulk density and from 2.1303 to 2.5878 g/ml for apparent density.

Microhardness of the cordierite based porous sintered glass-ceramic material can be determined herein, using the procedures of ASTM E-384 and is reported as Vickers Hardness (VH). Microhardness VH values for the porous sintered glass-ceramic of this invention can range from about 560 to 660 kg/mm² (Table 2).

The Coefficient of Thermal Expansion (CTE) is a conventional thermodynamic property of glass-ceramic material of the type prepared herein. The CTE of the cordierite-based glass-ceramic bodies as prepared herein will generally range from about 32.63 to −14.44 form room temperature to 300 and 500° C. respectively (Table 2).

### EXAMPLES

Silica′sand, kaolin clay and magnesite are the main raw materials provide with commercial boric acid, upon subsequent homogeneous mixing and heating, this mixtures of oxides shown in Table 1.

TABLE 1
Composition of cordierite batch in oxide wt %.

| | | | | | | | | | Commercial |
|---|---|---|---|---|---|---|---|---|---|
| | Oxides from raw materials in wt % | | | | | | | | chemical |
| | SiO₂ | Al₂O₃ | Fe₂O₃ | CaO | MgO | Na₂O | K₂O | TiO₂ | B₂O₃ * |
| Range | 50.00-60.00 | 10.00-25.00 | 0.50-1.50 | 0.50-1.50 | 10.00-15.00 | 0.01-0.02 | 0.01-0.02 | 0.50-2.50 | 5.00-20.00 |

* Commercial

Preparation of the porous sintered glass-ceramic bodies of the present invention is illustrated by the following: The starting raw materials with commercial boric acid are processed into glass ceramic discs following the procedure shown in FIG. 1. The batch of raw materials is thoroughly mixed and then melted in sintered alumina crucibles in the temperature up to 1450° C. The glass in the crucibles is then water quenched to form dark brown glass frits which is crushed and pulverized into powder in grains of less than 65 microns in average diameter. Glass powder is then consolidated into the discs by dry pressing at a compaction pressure of 15 KN using binder of PVA solution. The discs are then sintered at different temperatures ranging from 1000° C. to 1300° C. (1000° C.; 1050° C.; 1200° C.; 1250° C.; 1300° C.).

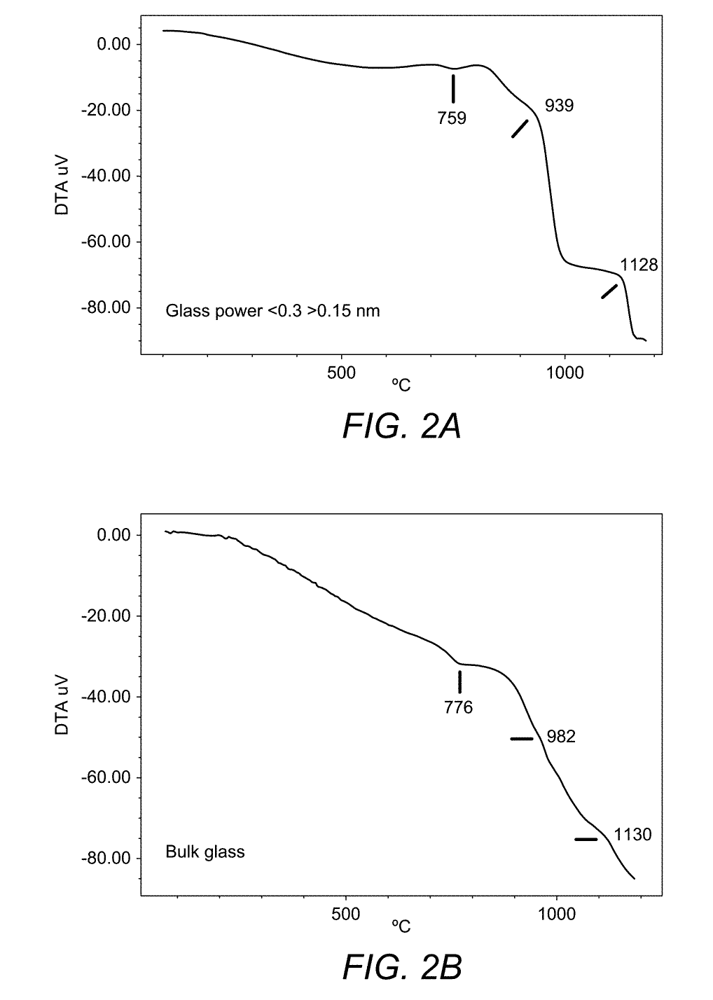

In FIG. 2 shows via differential thermal analysis that the softening temperature of each of powder or bulk glass ranges from 759° C. to 776° C. and the crystallization temperatures ranges from 939° C. to 1130° C. However, at higher temperatures, partial remelting takes place.

TABLE 2
Porosity and Densities, microhardness and CTE of Sintered
Glass-Ceramic Samples at 1200, 1250, and 1300° C.
Porosity % of the sintered glass-ceramic samples, at 1200
and 1300° C., were 8.99% and 56.42%, respectively.

| Property | 1200° C. | 1250° C. | 1300° C. |
|---|---|---|---|
| Density (g/mL) | | | |
| Bulk | 1.988 | 1.8708 | 1.1278 |
| Apparent (skeletal) | 2.1303 | 2.5823 | 2.5878 |
| Porosity (%) | 8.99 | 27.00 | 56.42 |
| Micro hardness (Kg/mm²) | 560 | 660 | 580 |
| Coefficient of Thermal Expansion | | | |
| (CET) (α × 10⁻⁷ ° C.⁻¹) | | | |
| 20-300° C. | 10.32 | 32.63 | 10.38 |
| 20-500° C. | 7.86 | −4.48 | −14.44 |

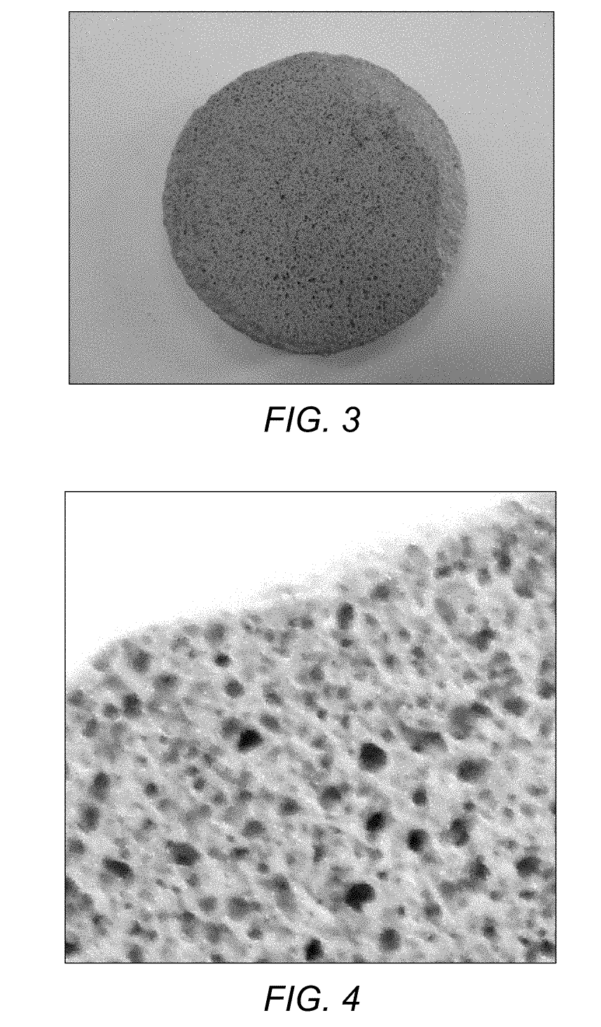

FIGS. 3 and 4 shows the appearance of macro and micro porous glass-ceramic disc sintered up to 1300° C. FIGS. 3 and 4 show the appearance of macro and micro porous glass ceramic discs sintered up to 1300° C. FIG. 4 shows the scaled general view of the discus with irregular pores that spread over the surface. The dark spots refer to the spread pores (FIG. 4b). These pores are irregular and range from <0.010 mm to ˜1 mm (FIGS. 4a and 4b). The fresh fracture surface of the sample show some connected pores (FIG. 4c). The connection of pores was confirmed by passage of water through the sample.

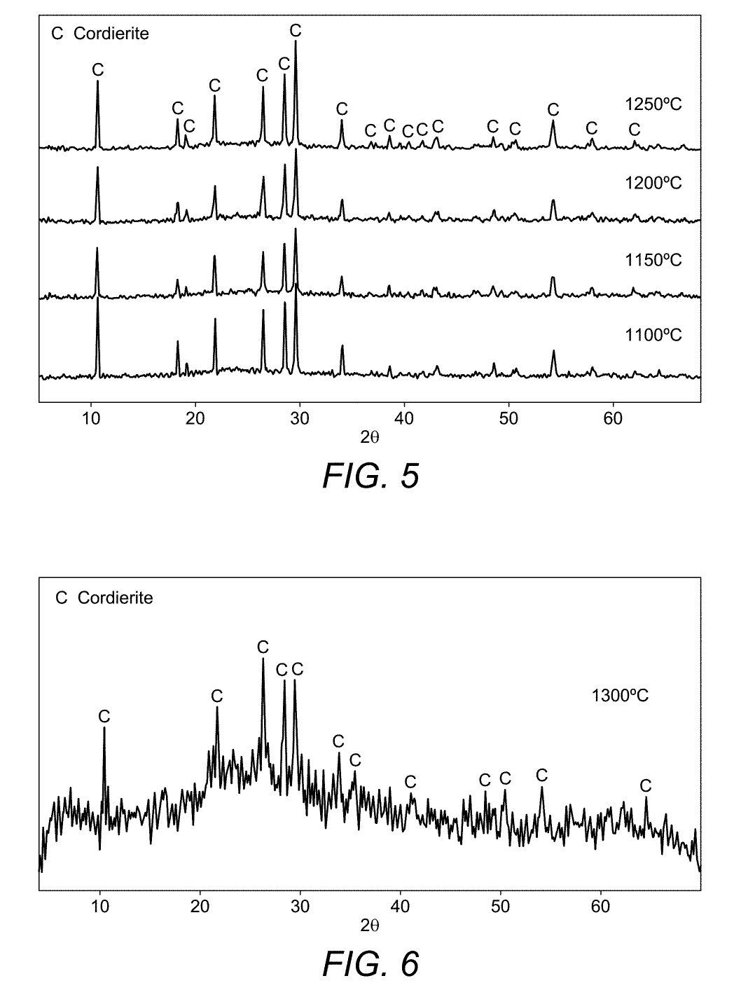

FIGS. 5 and 6 shows x-ray diffraction patterns of the present glass sintered at different temperatures. The patterns indicate that the glass-ceramic material is of cordierite alone. The x ray diffraction analysis in FIGS. 5 and 6 indicates that the patterns referred to cordierite alone (with the indexed d spacing at 8.46, 3.39, 3.15, 3.13, 3.03 and 2.65 Å, ICDD 12-0303). In the fact crystallization of mono-mineralic phase, mean an almost equal properties in all the sample.

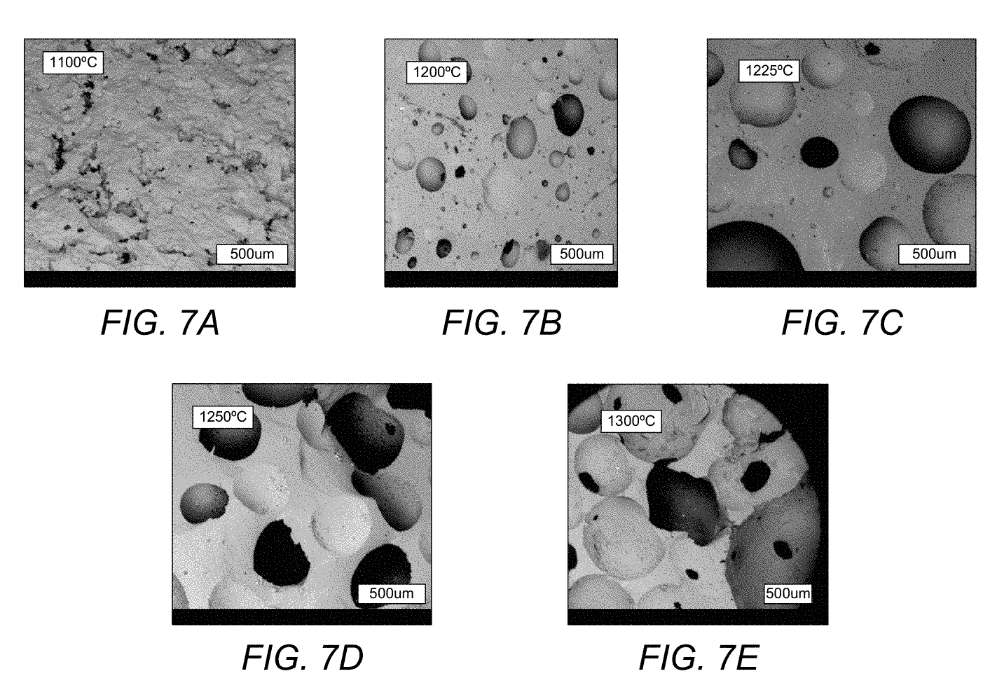

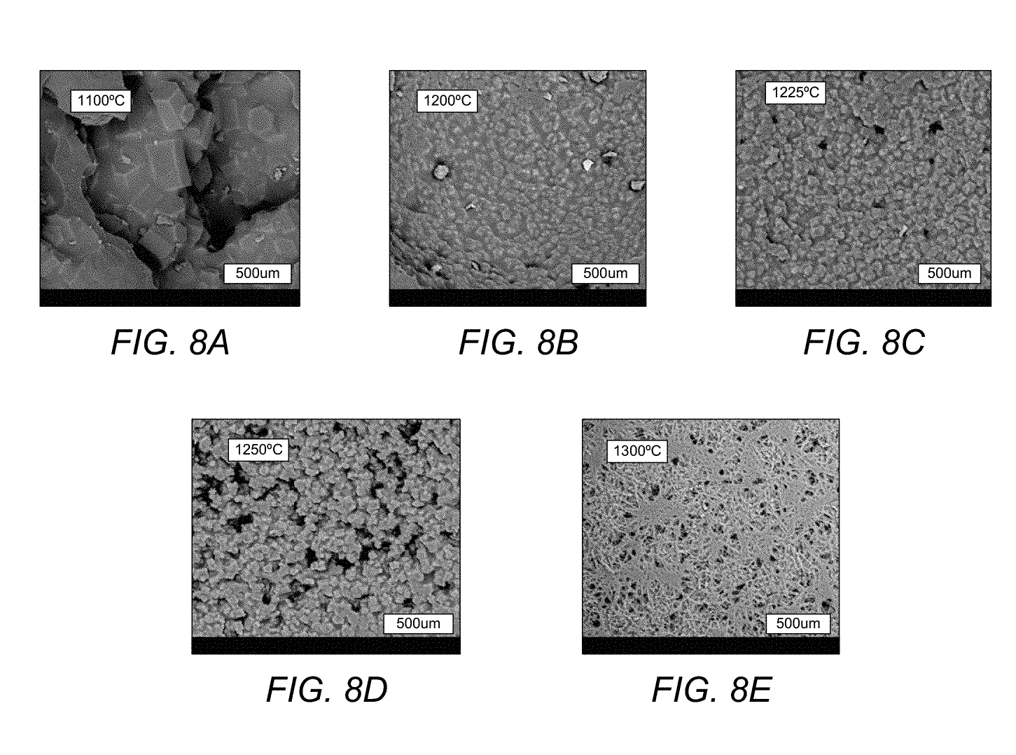

FIGS. 7 and 8 shows several SEM micrographs of the glass-ceramic samples sintered at different temperature. The scanning electron micrographs SEM (at one magnification) show increase of the pore size from ˜20 um at 1100 to >500 um at 1300 C, that is accompanied by some connection of pores especially the samples sintered at 1250 and 1300 (FIG. 7). However, the spread of hexagon cordierite crystals in the glassy matrix in all the SEM photos confirm the crystallization unique of monomineralic phase.

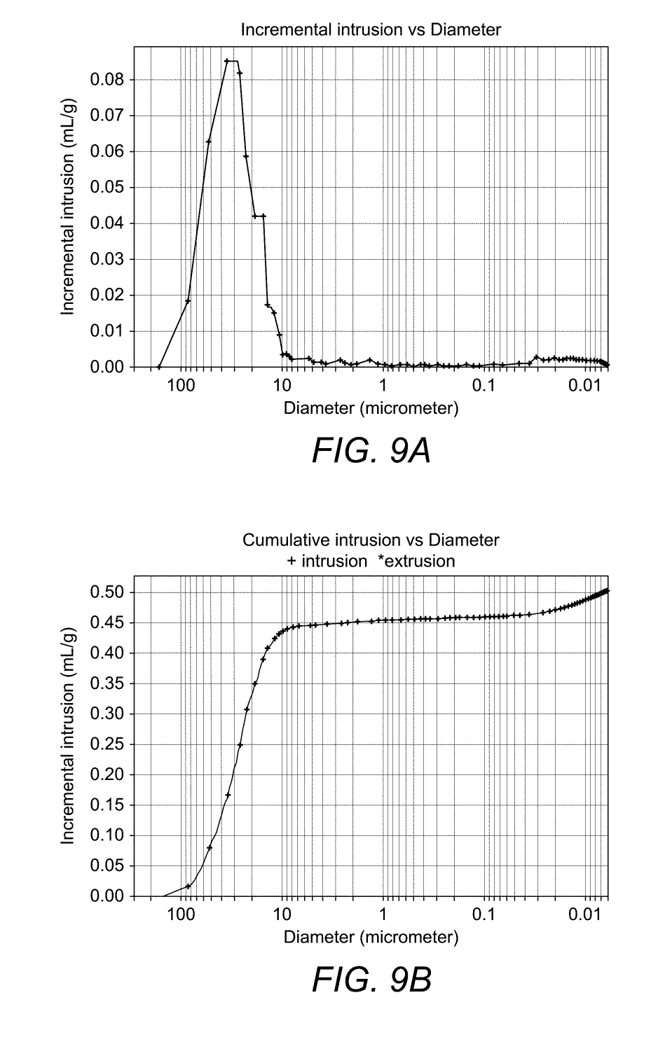

FIG. 9 shows the median pore diameter. The porosity of sintered glass-ceramic samples was measured using Porosimeter. The best results was obtained from the sample that treated at 1300° C. (Table 2), the results indicated that medium pore diameter is 26.600 um, the average pore diameter is 0.1429 um and the porosity is 56.

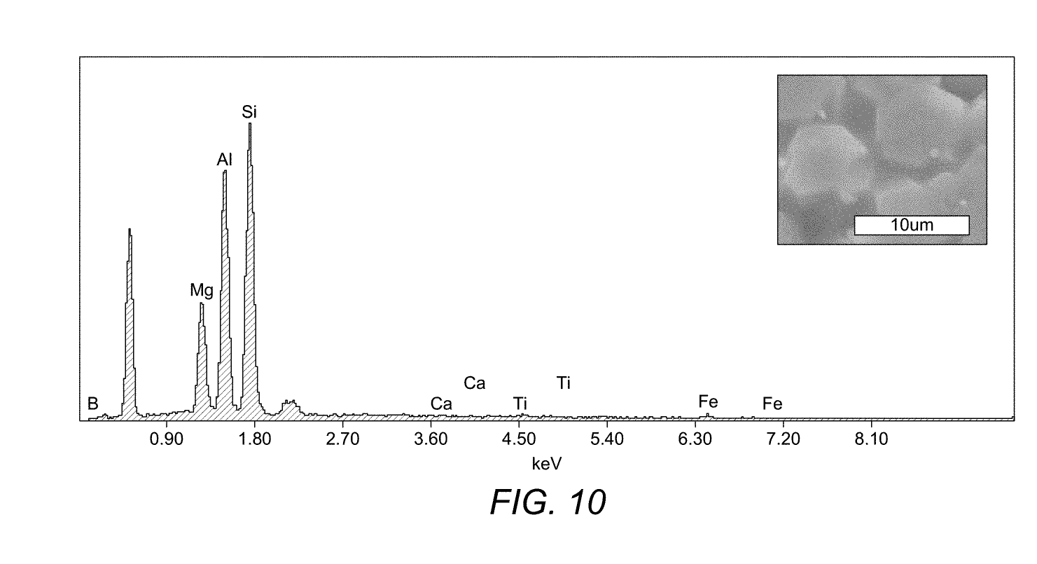

FIG. 10 shows the EDS micoranalysis of the euhadral hexagonal cordierite crystal formed in the porous sintered sample. The micoranalysis show the possible incorporation of boron in the cordierite structure

The Coefficient of Thermal Expansion (CTE) of the sintered samples ranges between 32.63 to −14.44×10-6° C.-1 from room temperature to 300 and 500° C. respectively. The microhardness values were between 560 to 660 Kg/mm2 (Table 2). The present results show the lower value of CTE, which is the characteristic of cordierite glass-ceramic, that mean it can use under temperature with very low expansion. In addition, the hardness, the resistance of the material to scratch, value according to Vicker's microhardness was between 560 and 660 kg/mm2 (between 5 and 6 moho scale). Little decrease of hardness value, than the usual on may be due to the incorporation of boron in cordierite structure or the residual glass.

What is claimed is:

1. A method of preparing a porous mono-cordierite glass-ceramic material, comprising:
a) mixing and homogenizing a natural raw material, a mixture of oxide and a commercial material, wherein the natural raw material is a silica sand, kaolin and magnesite and the commercial material is a boric acid;
b) Melting the homogenized the natural raw materials with boric acid at a temperature of from about 1400° C. to 1450° C. to form a glass frit material;
c) crushing the frit glass material that is quenched to form a crushed glass powder having a particle size diameter of no greater than about 65 microns;
d) consolidating the crushed glass powder into a green body;
e) sintering the green body at a temperature of from about 1000° C. to 1300° C. for a specific time to devitrify and form a porous polycrystalline material; and
f) cooling porous polycrystalline material to form a cordierite polycrystalline material.

2. The method according to claim 1 wherein said mixture of oxides has 0.50 wt % to 01.50 wt % of CaO; 0.01 wt % to 0.20 wt % of Na₂O, 0.01 wt % to 0.20 wt % of K₂O, 0 50 wt % to 60 wt % of SiO₂, 10 wt % to 25 wt % of Al₂O₃, 5.00 wt % to 20 wt % B₂O₃, 10 wt % to 15 wt % of MgO, 0.5 wt % to 2.5 wt % of TiO₂, 0.5 to 1.5 wt % of Fe₂O₃, and 0.50 to 1.50 wt % of CaO.

3. The method according to claim 1, wherein said silica sand, kaolin and magnesite are combined to provide a combination of raw materials comprising 10.00 wt % to 45.00 wt % of silica sand, 31.00 wt % to 87.00 wt % of kaolin, 15.00 wt % to 17.00 wt % of magnesite and boric acid from 10 to 35 wt %.

4. The method according to claim 1, wherein said quenched glass is crushed to frit having an average grain size of no greater than about 65 microns.

5. The method according to claim 1, wherein said crushed powder is consolidated into a green body at a compaction pressure ranging from about 10 KN to 20 KN.

6. The method according to claim 1, wherein sintering is done at a temperature of from about 1000° C. to 1300° C. for the specific time between 1 min to 1 hour.

7. The method according to claim 1, wherein said polycrystalline phase in said porous sintered glass-ceramic body mainly from cordierite with residual glass.
